(19) United States
(12) Patent Application Publication
(10) Pub. No.: US 2026/0210508 A1
(43) Pub. Date: Jul. 23, 2026

(54) FLAT MICRO-LED FOR HEADLIGHT

(71) Applicant: VueReal Inc., Waterloo (CA)

(72) Inventors: Gholamreza CHAJI, Waterloo (CA); John CRONIN, Jericho, VT (US)

(73) Assignee: VueReal Inc., Waaterloo, ON (CA)

(21) Appl. No.: 19/137,506

(22) PCT Filed: Dec. 19, 2023
(86) PCT No.: PCT/CA2023/051698

§ 371 Date: Jun. 10, 2025

Related U.S. Application Data
(60) Provisional application No. 63/477,015, filed on Dec. 23, 2022.

(51) Int. Cl. F21S 41/143; B60Q 1/04

(52) U.S. Cl. CPC F21S 41/143; B60Q 1/04

(57) ABSTRACT

A Micro-LED-based vehicle headlight. Micro-LEDs may be arranged in a panel with density to create the same or similar intensity light as existing headlight designs or to conform with legal requirements. These Micro-LED headlights may allow for cheaper, more energy efficient, smaller, and/or more customizable headlights.

### BACKGROUND AND FIELD OF THE DISCLOSURE

The present disclosure is generally related to the application of micro-LED lighting to automotive applications.

Due to the required brightness of vehicle headlights, they often take up a large volume of the front of a vehicle.

Headlights can be costly, especially on larger vehicles or vehicles with computerized headlight control.

Headlights produce heat as a byproduct of generating light. This heat is wasted energy and can be harmful to the vehicle and human operators.

Headlights can be cumbersome and weighty, reducing the vehicle's speed, gas efficiency, and aerodynamics. While also making them more costly to store and transport.

While not the most expensive part of a vehicle to replace, headlights can still be costly, depending on what kind of headlight technology a vehicle uses. Some bulbs may be as expensive as $100 to replace each, and some traditional LED headlights can require entire headlight assembly replacement.

### SUMMARY

The present invention relates to a Micro-LED vehicle headlight system comprising, a Micro-LED panel comprised of a plurality of Micro-LEDs, a substrate to which a Micro-LED tile is bound, a connector integrating electronics of the Micro-LED panel with a vehicle and wherein the Micro-LED panel performs a function of a vehicle headlight.

### DESCRIPTIONS OF THE DRAWINGS

In this description, the term “micro-LED” and “microdevice” are used interchangeably.

FIG. 1: Illustrates an integration of a transferred microdevice with an electro-optical thin film device in a hybrid structure, according to an embodiment.

FIG. 2: Illustrates a flat Micro-LED panel for a headlight, according to an embodiment.

FIG. 3: Illustrates a flat Micro-LED panel for a headlight with a lens, according to an embodiment.

FIG. 4: Illustrates a flat Micro-LED panel for a headlight laminated to a glass window, according to an embodiment.

FIG. 5: Illustrates Micro-LED tiles on a shaped glass panel, according to an embodiment.

FIG. 6: Illustrates a flat Micro-LED panel for a headlight with multiple Micro-LED patterns, according to an embodiment.

FIG. 7: Illustrates a flat Micro-LED panel for a headlight with multiple Micro-LED zones, according to an embodiment.

FIG. 8: Illustrates a flat Micro-LED panel for a headlight with a protective layer, according to an embodiment.

### DETAILED DESCRIPTION

Embodiments of the present disclosure will be described more fully hereinafter with reference to the accompanying drawings in which numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples. Embodiments also relate to structure, systems and methods of interior and exterior lighting in automobiles.

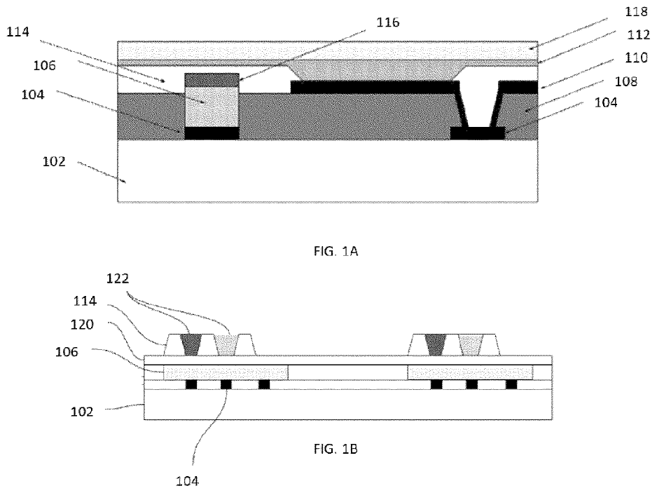

FIG. 1A shows an example of integrating a transferred microdevice 106 with an electro-optical thin film device 112 in a hybrid structure. This is an example of an integrated micro-LED tile that is later picked and placed into an array of tiles. It should be obvious to those in the art there are many ways to create micro-LED tiles and integrate them in an array of tiles, as per US20160218143A1—Microdevice integration into system substrate. A receiver substrate 102 and contact pads 104 upon which the microdevice 106 arrays are transferred and into which the thin film electro-optical device is integrated in a number of hybrid structure embodiments. Microdevice 106 may be transferred and bonded to the bonding pad 104 of the receiver substrate 100. In one case, a dielectric layer 108 is formed over the substrate 102 to cover the exposed electrodes and conductive layers. Lithography and etching may be used to pattern the dielectric layer 108. Conductive layer 110 is then deposited and patterned to form the bottom electrode of the thin film electro-optical device 112. If there is no risk of unwanted coupling between bottom electrode 110 and other conductive layers in the receiver substrate, the dielectric layer 108 may be eliminated. However, this dielectric layer can also act as a planarization layer to offer better fabrication of electro-optical devices 112. A bank layer 114 is deposited on the substrate 102 to cover the edges of the electrode 110 and the microdevice 106. Thin film electro-optical device 112 is then formed over this structure. Organic LED (OLED) devices are an example of a thin film electro-optical device that may be formed using different techniques, including but not limited to shadow mask, lithography, and printing patterning. Finally, the top electrode 118 of the electro-optical thin film device 112 is deposited and patterned if needed. In an embodiment where the microdevices' 106 thickness is significantly high, cracks or other structural problems may occur within the bottom electrode 110. In these embodiments, a planarization layer may be used in conjunction with or without the dielectric layer 108 to address this issue.

In another embodiment, the microdevice 106 can have a device electrode 116. This electrode can be common between other microdevices 106 in the system substrate. In this case, the planarization layer (if present) and/or bank structure 114 covers the electrode 116 to avoid any shorts between the electro-optical device 112 and device electrode 116.

FIG. 1B illustrates structures where the device is shared between a few pixels (or sub-pixels) after post-processing to deposit a common electrode and color conversion layers. Here the microdevice 106 is not fully patterned, but the horizontal condition is engineered so that the contacts 104 define the area allocated to each pixel. The system substrate 102 with contact pads 104 and a donor substrate with microdevices 106. After the microdevices 106 are transferred to system substrate 102, one can do post-processing, such as depositing common electrode 120, color conversion layers 122, color filters, and so on. However, the methods described in this disclosure and other possible methods can be used.

It is possible to add the color conversion layers as described into pixel (or sub-pixel) active areas after forming the active area. This can offer a higher fill factor and higher performance and avoid color leaking from the side pixel (or sub-pixel) if the active area of the pixel (or sub-pixel) is covered by reflective layers. The microdevices 106 are grown on a buffer/sacrificial layer in another embodiment.

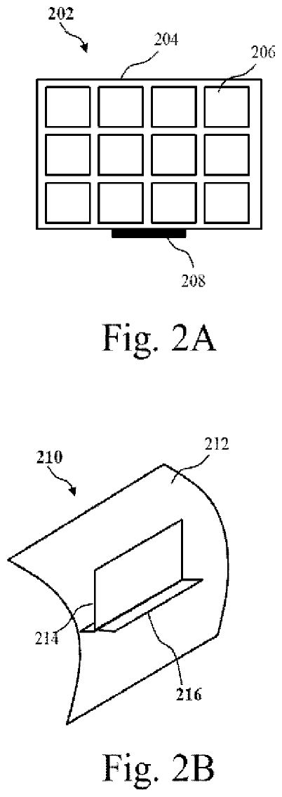

FIG. 2A displays a flat Micro-LED panel for a headlight. FIG. 2B displays a structure which may contain the Micro-LED panel of FIG. 2A. Element 202 may be a Micro-LED panel which may be comprised of one or more tiles that contain multiple Micro-LEDs. Multiple small Micro-LED tiles can be integrated together into a larger flat plate. The panel may contain Micro-LEDs in the density to create the same light as the existing headlights. The panel may use RGB Micro-LEDs or Blue Micro-LEDs with Phosphorus to get white light. Element 204 may be a substrate to which the Micro-LED tiles may be bound. The substrate may be silicon, glass, sapphire, any other substrate known in the art, any material to which Micro-LED tiles can be bound, or any combination of these materials. The substrate may further house or be bound to electronics which connect to the Micro-LEDs. These electronics may be contained within the substrate, tunnel through the substrate to reach the Micro-LEDs, or use the substrate as part of the circuit. Element 206 may be a Micro-LED tile comprised of multiple Micro-LEDs. Element 208 may be a connector which allows the electronics of the Micro-LED panel of FIG. 2A to connect to the electronics system of the vehicle. This may allow the Micro-LED panel to be powered and controlled by the vehicle, and to give feedback information to the vehicle. Element 210 may be a structure that houses the Micro-LED panel of FIG. 2A. This structure may conform to the shape of headlights in existing or upcoming car models, so they could be interchanged with non-Micro-LED headlights. Element 212 may be a window that allows the light from the Micro-LEDs through. The window may comprise glass, plastic, crystal, transparent or semi-transparent material, or any combination of these materials. The window may contain lenses or patterns which may diffuse, focus, polarize, block, redirect, or otherwise interact with the light coming from the Micro-LEDs. Element 214 may be the Micro-LED panel of FIG. 2A. Element 216 may be a stand or base which holds the Micro-LED Panel in place with respect to the vehicle. The stand or base may also ensure that the electronic connection between the Micro-LED panel and the vehicle is not broken. The Micro-LED panel may be closer to the window than a typical headlight bulb, thereby reducing the space required for headlights. While the initial costs of Micro-LED headlights may be more than traditional headlights, costs may be saved in other areas, such as replacement and energy costs. Micro-LEDs are more efficient than traditional headlights and so produce less heat and waste less energy. Because of the reduced required volume, Micro-LED headlights may be lighter than their traditional counterparts. The replacement costs for Micro-LED headlights may be less than other headlights due to the small size of the Micro-LED panel, meaning replacement is likely to be less invasive and may be easy enough to do without vehicle maintenance expertise.

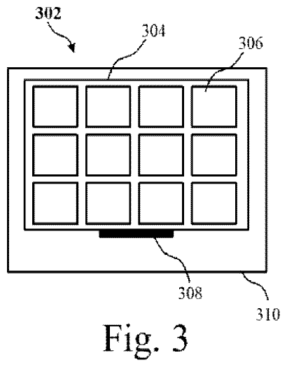

FIG. 3 displays a flat Micro-LED panel for a headlight with a lens. Element 302 may be a Micro-LED panel which may be comprised of one or more tiles that contain multiple Micro-LEDs. Multiple small Micro-LED tiles can be integrated together into a larger flat plate. The panel may contain Micro-LEDs in the density to create the same light as the existing headlights. The panel may use RGB Micro-LEDs or Blue Micro-LEDs with Phosphorus to get white light. Element 304 may be a substrate to which the Micro-LED tiles may be bound. The substrate may be silicon, glass, sapphire, any other substrate known in the art, any material which Micro-LED tiles can be bound, or any combination of these materials. The substrate may further house or be bound to electronics which connect to the Micro-LEDs. These electronics may be contained within the substrate, tunnel through the substrate to reach the Micro-LEDs, or use the substrate as part of the circuit. Element 306 may be a Micro-LED tile comprised of multiple Micro-LEDs. Element 308 may be a connector which allows the electronics of the Micro-LED panel of FIG. 3 to connect to the electronics system of the vehicle. This may allow the Micro-LED panel to be powered and controlled by the vehicle and to give feedback information to the vehicle. Element 310 may be a lens which may allow for focusing Micro-LEDs in a fixed position on the road. The lens may be connected to or embedded in the substrate. The lens may comprise glass, plastic, crystal, transparent or semi-transparent material, or any combination of these materials. The lens may diffuse, focus, polarize, block, redirect, or otherwise interact with the light from the Micro-LEDs. The Micro-LED panel may not require a window or empty space between the light source and lens, thereby reducing the space required for headlights. While the initial costs of Micro-LED headlights may be more than traditional headlights, costs may be saved in other areas, such as replacement costs and energy costs. Micro-LEDs are more efficient than traditional headlights and produce less heat and waste less energy. Because of the reduced required volume, Micro-LED headlights may be lighter than their traditional counterparts. The replacement costs for Micro-LED headlights may be less than other headlights due to the small size of the Micro-LED panel, meaning replacement is likely to be less invasive and may be easy enough to do without vehicle maintenance expertise. Because the lens is so close to the light source, the Micro-LED panel may be connected externally to the vehicle.

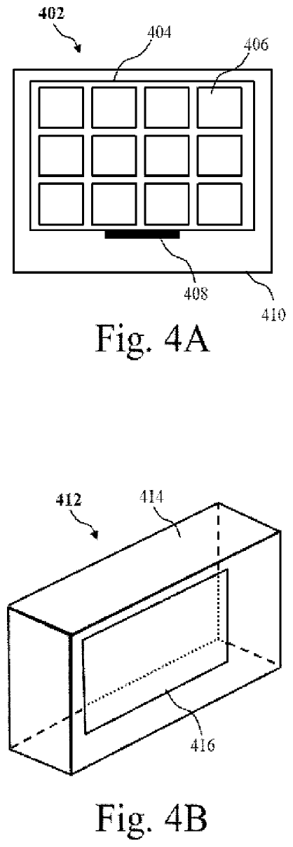

FIG. 4A displays a flat Micro-LED panel for a headlight laminated to a glass window. FIG. 4B displays an isometric view of FIG. 4A and the laminate structure. Element 402 may be a Micro-LED panel which may be comprised of one or more tiles that contain multiple Micro-LEDs. Multiple small Micro-LED tiles can be integrated together into a larger flat plate. The panel may contain Micro-LEDs in the density to create the same light as the existing headlights. The panel may use RGB Micro-LEDs or Blue Micro-LEDs with Phosphorus to get white light. Element 404 may be a substrate to which the Micro-LED tiles may be bound. The substrate may be silicon, glass, sapphire, any other substrate known in the art, any material to which Micro-LED tiles can be bound, or any combination of these materials. The substrate may further house or be bound to electronics which connect to the Micro-LEDs. These electronics may be contained within the substrate, tunnel through the substrate to reach the Micro-LEDs, or use the substrate as part of the circuit. Element 406 may be a Micro-LED tile comprised of multiple Micro-LEDs. Element 408 may be a connector which allows the electronics of the Micro-LED panel of FIG. 4A to connect to the electronics system of the vehicle. This may allow the Micro-LED panel to be powered and controlled by the vehicle and to give feedback information to the vehicle. Element 410 may be a laminate material such as plastic or epoxy, which coats the Micro-LED panel and adheres it to a pane of glass. The laminate material may also protect the electronics or other fragile components of the Micro-LED panel. Element 412 may be the entire laminate structure, including the laminated Micro-LED of FIG. 4A and glass encasement. Element 414 may be a glass encasement in which the Micro-LED panel is adhered to by the laminate material. This glass encasing may be shaped such that it can attach to a vehicle at multiple locations, not just where the traditional headlights may be. The glass encasement may be existing glass or other glass-like material that is already part of the vehicle, such as the existing headlight encasement, the windshield, a window, etc. Element 416 may be the Micro-LED panel of FIG. 4A. The Micro-LED panel may be laminated to the window, thereby reducing the space required for headlights. While the initial costs of Micro-LED headlights may be more than traditional headlights, costs may be saved in other areas, such as replacement costs and energy costs. Micro-LEDs are more efficient than traditional headlights and produce less heat and waste less energy, which means that the Micro-LED panel does not need as much space for ventilation. Because of the reduced required volume, Micro-LED headlights may be lighter than their traditional counterparts. The replacement costs for Micro-LED headlights may be less than other headlights due to the small size of the Micro-LED panel, meaning replacement is likely to be less invasive and may be easy enough to do without vehicle maintenance expertise.

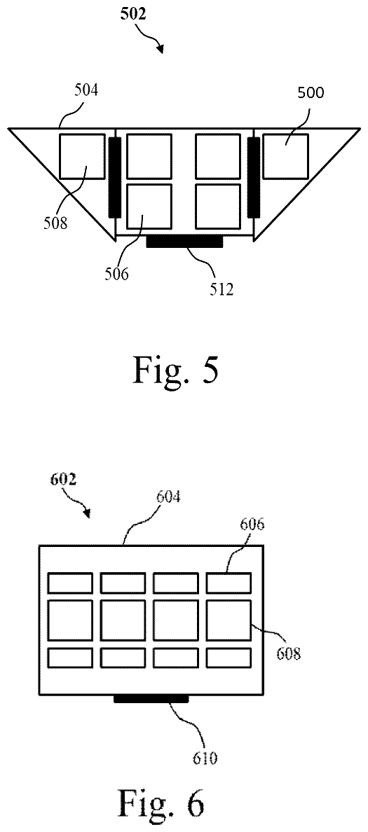

FIG. 5 displays Micro-LED tiles on a shaped glass panel. Element 502 may be a Micro-LED panel comprised of one or more tiles containing multiple Micro-LEDs on or in a shaped glass. The Micro-LED tiles may be embedded or integrated into the shaped glass. The Micro-LED tiles may be fixed to a flexible substrate which is then laminated or otherwise adhered to the shaped glass. Multiple small Micro-LED tiles can be integrated together into a larger flat plate. The panel may contain Micro-LEDs in the density to create the same light as the existing headlights. The panel may use RGB Micro-LEDs or Blue Micro-LEDs with Phosphorus to get white light. Element 504 may be shaped glass to which the Micro-LED tiles may be bound. The glass may be made of materials other than silicon dioxide glass, such as silicon, sapphire, any other substrate known in the art, any material which Micro-LED tiles can be bound, or any combination of these materials. The glass may be shaped as one piece or a combination of glass plates that are connected. Element 506 may be a Micro-LED tile comprised of multiple Micro-LEDs on a front-facing part of the shaped glass. Element 508 may be a Micro-LED tile comprised of multiple Micro-LEDs on an angled part of the shaped glass. Element 510 may be a Micro-LED tile comprised of multiple Micro-LEDs on a second angled part of the shaped glass. Element 512 may be a connector that allows the electronics of the Micro-LED panel of FIG. 5 to connect to the vehicle's electronics system. This may allow the Micro-LED panel to be powered and controlled by the vehicle and to give feedback information to the vehicle. The Micro-LED panel may be closer to the window than a typical headlight bulb, thereby reducing the space required for headlights. While the initial costs of Micro-LED headlights may be more than traditional headlights, costs may be saved in other areas, such as replacement costs and energy costs. Micro-LEDs are more efficient than traditional headlights and produce less heat and waste less energy. Because of the reduced required volume, Micro-LED headlights may be lighter than their traditional counterparts. The replacement costs for Micro-LED headlights may be less than other headlights due to the small size of the Micro-LED panel, meaning replacement is likely to be less invasive and may be easy enough to do without vehicle maintenance expertise.

FIG. 6 displays a flat Micro-LED panel for a headlight with multiple Micro-LED patterns. Element 602 may be a Micro-LED panel which may be comprised of one or more tiles that contain multiple Micro-LEDs. Multiple small Micro-LED tiles can be integrated together into a larger flat plate. The panel may contain Micro-LEDs in the density to create the same light as the existing headlights. The panel may use RGB Micro-LEDs or Blue Micro-LEDs with Phosphorus to get white light. Different shapes of Micro-LED tiles can be used to create patterns. These patterns may be used for the aesthetics of the final light being cast, organizing light patterns, such as high beams or low beams, or indicating directions (left or right) when these specific tiles are activated. Element 604 may be a substrate to which the Micro-LED tiles may be bound. The substrate may be silicon, glass, sapphire, any other substrate known in the art, any material which Micro-LED tiles can be bound, or any combination of these materials. The substrate may further house or be bound to electronics which connect to the Micro-LEDs. These electronics may be contained within the substrate, tunnel through the substrate to reach the Micro-LEDs, or use the substrate as part of the circuit. Element 606 may be the first type of Micro-LED tile comprised of multiple Micro-LEDs. Element 608 may be a second type of Micro-LED tile comprised of multiple Micro-LEDs with a shape, structure, color, or other distinguishing factors, that differs from the first type of Micro-LED tile. Element 610 may be a connector that allows the electronics of the Micro-LED panel of FIG. 6 to connect to the vehicle's electronics system. This may allow the Micro-LED panel to be powered and controlled by the vehicle and to give feedback information to the vehicle. The Micro-LED panel may be closer to the window than a typical headlight bulb, thereby reducing the space required for headlights. While the initial costs of Micro-LED headlights may be more than traditional headlights, costs may be saved in other areas, such as replacement costs and energy costs. Further, the patterned Micro-LED headlight may serve multiple functions and replace more than one light on a vehicle. For example, the Micro-LED panel may act as both a headlight and a turn signal light. Micro-LEDs are more efficient than traditional headlights and so produce less heat and waste less energy. Because of the reduced required volume, Micro-LED headlights may be lighter than their traditional counterparts. The replacement costs for Micro-LED headlights may be less than other headlights due to the small size of the Micro-LED panel, meaning replacement is likely to be less invasive and may be easy enough to do without vehicle maintenance expertise.

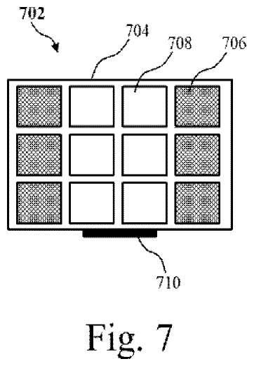

FIG. 7 displays a flat Micro-LED panel for a headlight with multiple Micro-LED zones. Element 702 may be a Micro-LED panel which may be comprised of one or more tiles that contain multiple Micro-LEDs. Multiple small Micro-LED tiles can be integrated together into a larger flat plate. The panel may contain Micro-LEDs in the density to create the same light as the existing headlights. The panel may use RGB Micro-LEDs or Blue Micro-LEDs with Phosphorus to get white light. Different groups of Micro-LED tiles can be used to create zones. These zones may represent high beams, low beams, directional, night lights, running lights, various colors, densities, etc. Element 704 may be a substrate to which the Micro-LED tiles may be bound. The substrate may be silicon, glass, sapphire, any other substrate known in the art, any material to which Micro-LED tiles can be bound, or any combination of these materials. The substrate may further house or be bound to electronics which connect to the Micro-LEDs. These electronics may be contained within the substrate, tunnel through the substrate to reach the Micro-LEDs, or use the substrate as part of the circuit. Element 706 may be a Micro-LED tile comprised of multiple Micro-LEDs in a first zone. Element 708 may be a Micro-LED tile comprised of multiple Micro-LEDs in a second zone which differs from the first zone in location, the intensity of Micro-LED tiles, the color of Micro-LED tiles, direction, any other differentiating factor, or any combination of factors. Element 710 may be a connector which allows the electronics of the Micro-LED panel of FIG. 7 to connect to the electronics system of the vehicle. This may allow the Micro-LED panel to be powered and controlled by the vehicle and to give feedback information to the vehicle.

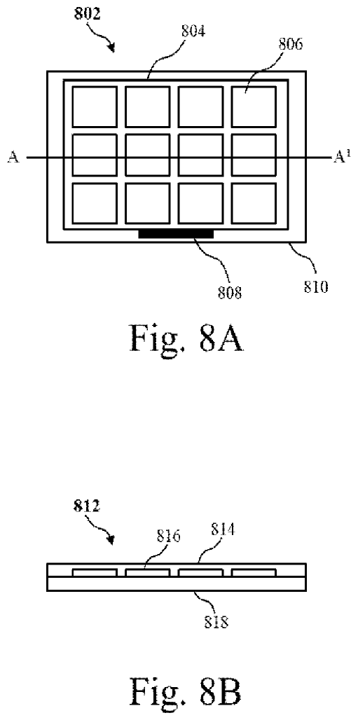

FIG. 8A displays a flat Micro-LED panel for a headlight with a protective layer. FIG. 8B displays a side view of FIG. 8A Element 802 may be a Micro-LED panel which may be comprised of one or more tiles that contain multiple Micro-LEDs. Multiple small Micro-LED tiles can be integrated together into a larger flat plate. The panel may contain Micro-LEDs in the density to create the same light as the existing headlights. The panel may use RGB Micro-LEDs or Blue Micro-LEDs with Phosphorus to get white light. Element 804 may be a substrate to which the Micro-LED tiles may be bound. The substrate may be silicon, glass, sapphire, any other substrate known in the art, any material to which Micro-LED tiles can be bound, or any combination of these materials. The substrate may further house or be bound to electronics which connect to the Micro-LEDs. These electronics may be contained within the substrate, tunnel through the substrate to reach the Micro-LEDs, or use the substrate as part of the circuit. Element 806 may be a Micro-LED tile comprised of multiple Micro-LEDs. Element 808 may be a connector which allows the electronics of the Micro-LED panel of FIG. 8A to connect to the electronics system of the vehicle. This may allow the Micro-LED panel to be powered and controlled by the vehicle and to give feedback information to the vehicle. Element 810 may be a protective layer. The protective layer may protect from environmental and/or vibrational damage. The protective layer may be made of glass, epoxy, plastic, metal, other protective materials, or any combination of protective materials. The protective layer may be hermetically sealed. Element 812 may be the Micro-LED panel of element 802. Element 814 may be the protective layer of element 810. Element 816 may be the Micro-LED tile of element 806. Element 818 may be the substrate of element 804. The Micro-LED panel may be closer to the window than a typical headlight bulb, thereby reducing the space required for headlights. While the initial costs of Micro-LED headlights may be more than traditional headlights, costs may be saved in other areas, such as replacement costs and energy costs. Micro-LEDs are more efficient than traditional headlights and produce less heat and waste less energy. Because of the reduced volume required, Micro-LED headlights may be lighter than their traditional counterparts. The replacement costs for Micro-LED headlights may be less than other headlights due to the small size of the Micro-LED panel, meaning replacement is likely to be less invasive and may be easy enough to do without vehicle maintenance expertise. The protective seal may reduce the rate at which the Micro-LED headlight needs to be replaced compared to traditional headlights.

The functions performed in the processes and methods may be implemented in differing orders. Furthermore, the outlined steps and operations are only provided as examples, and some of the steps and operations may be optional, combined into fewer steps and operations, or expanded into additional steps and operations without detracting from the essence of the disclosed embodiments.

1. A Micro-LED vehicle headlight system comprising:
a Micro-LED panel comprised of a plurality of Micro-LEDs;
a substrate to which a Micro-LED tile is bound;
a connector integrating electronics of the Micro-LED panel with a vehicle; and
wherein the Micro-LED panel performs a function of a vehicle headlight.

2. The system of claim 1, wherein the Micro-LED panel comprises of one or more tiles containing multiple Micro-LEDs.

3. The system of claim 2, wherein multiple small Micro-LED tiles are integrated together into a larger flat plate.

4. The system of claim 2, wherein the panel contains Micro-LEDs in a density to enable creating a same light as conventional LED and non LED headlights.

5. The system of claim 2, wherein the panel uses RGB Micro-LEDs or Blue Micro-LEDs with Phosphorus to get white light.

6. The system of claim 2, wherein the substrate is one of silicon, glass, sapphire, or any material to which Micro-LED tiles are bounded or any combination of these materials.

7. The system of claim 2, wherein the substrate further houses or is bound to electronics which connects to the Micro-LEDs.

8. The system of claim 2, wherein a first element is a connector allowing electronics of the panel to connect to electronics system of a vehicle which further allows the Micro-LED panel to be powered and controlled by the vehicle, and give a feedback information to the vehicle.

9. The system of claim 2, wherein a second element is a structure housing the Micro-LED panel and conforms to a shape of headlights.

10. The system of claim 9, wherein the shape interchangeable with non-Micro-LED headlights of existing vehicles.

11. The system of claim 2, wherein a third element is a window allowing the light from the Micro-LEDs and is comprised of either a glass, a plastic, a crystal, a transparent or a semi-transparent material, or any combination of these materials wherein further the window contains lenses or patterns which diffuse, focus, polarize, block, redirect, or otherwise interact with the light coming from the Micro-LEDs.
